(19) United States
(12) Patent Application Publication
(10) Pub. No.: US 2025/0122339 A1
(43) Pub. Date: Apr. 17, 2025

(54) SOLUBLE POLYIMIDES FOR COATING ON POLYMERIC SUBSTRATES

(71) Applicant: HD MICROSYSTEMS, Wilmington, DE (US)

(72) Inventors: C. Chad ROBERTS, Wilmington, DE (US); John Donald SUMMERS, Durham, NC (US); Wei LI, Charlotte, NC (US)

(21) Appl. No.: 18/291,329

(22) PCT Filed: Aug. 5, 2022
(86) PCT No.: PCT/US2022/039512

§ 371 Date: Jan. 23, 2024

Related U.S. Application Data
(60) Provisional application No. 63/232,739, filed on Aug. 13, 2021.

(51) Int. Cl. C08G 73/10; C09D 7/20; C09D 179/08

(52) U.S. Cl. CPC C08G 73/1007; C08G 73/1039; C08G 73/1053; C08G 73/1071; C09D 7/20; C09D 179/08; C08G 2150/00

(57) ABSTRACT

A composition comprising 5-30 weight percent of a polyimide and a solvent having boiling point of less than 150° C., and optionally further comprising a pigment, where the polyimide is soluble in the solvent and is the dehydrated reaction product of a dianhydride component and a diamine component. A method of coating the composition on a substrate comprising a flexible polymer.

### CROSS-REFERENCE TO RELATED APPLICATIONS

This application claims the benefit of U.S. Provisional Application No. 63/232,739 filed Aug. 13, 2021, the disclosure of which is incorporated herein by reference in its entirety.

### FIELD OF THE INVENTION

The field of this invention is a solution of polyimide and pigment, a method of coating such solution, particularly on polymeric substrates, and a coated polymeric substrate so formed.

### BACKGROUND

Certain polyimides find use as electrically insulating layers or as passivation films, for example in manufacture of integrated circuits. However, polyimides can be expensive. Thus, despite their desirable material properties it can be uneconomical to use them in certain large scale or lower cost applications.

In addition, frequently polyimides films or layers are formed by cure or dehydration of polyamic acids that have been coated onto the substrate. Such cure/dehydration occurs at elevated temperatures that can make the polyimides unsuitable for use as a coating layer on polymers having lower glass transition temperatures (Tg) or melting temperatures (Tm).

A need exists for a polyimide composition that can economically be used in lower cost, larger scale applications and/or that can be applied to a relatively low Tg or Tm polymeric substrates.

### SUMMARY OF THE INVENTION

Disclosed herein is a composition comprising 5-30 weight percent of a polyimide wherein the polyimide is the dehydrated reaction product of a dianhydride component and a diamine component, where the dianhydride component comprises at least 85, preferably at least 90, more preferably at least 95, yet more preferably at least 99, and most preferably 100 mole percent diphthalic anhydride having the structure

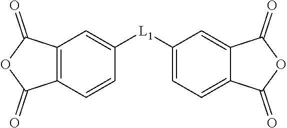

where L₁ is a linking group selected from —O—, —O-Ar1-O—, where Ar1 is a group comprising one or more aromatic ring, and where the diamine component comprises at least 95, preferably at least 98, and most preferably 100 mole percent of diamine having the structure

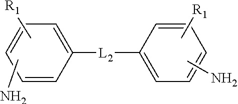

where the amine groups are at the meta or para positions, where the R₁ group is H or a substituted alkyl of 1-3 carbon atoms, L₂ is a direct bond or a linking group selected from —O—, —SO₂—, —OAr₂O—, —R₂Ar₂R₂— where R₂ is an alkyl group of 1-4 carbon atoms and Ar₂ is a group comprising one or more aromatic rings; a solvent having a boiling point of less than 150° C., and 0-15 weight % of one or more pigments. The polyimide can be soluble in the solvent.

Also disclosed herein is a method comprising providing the composition as described above and coating (e.g., by gravure coating) the composition onto a substrate (e.g., a flexible polymeric substrate comprising polyethylene terephthalate or polyethylene naphthalene), drying to form a film on the substrate having a thickness of 1 to 5 micrometers.

Also disclosed herein is an article which can be made by the method described above and characterized by one or more of the following the film has a dielectric constant of 4-10, the film a percent transmission at 400-750 nm of 1-80%, the film has a breakdown voltage of at least 200 volts/micron.

### DETAILED DESCRIPTION OF THE INVENTION

Applicant found that presence of a pigment in a polyimide precursor formulation which includes a polyamic acid can create problems in processing.

Disclosed herein is a composition comprising 5-30 wt % of a polyimide and a solvent having a boiling point of less than 150° C., where the polyimide is soluble in the amount at which it is present in the solvent. The composition can further include a pigment in amounts up to 15, or up to 10 weight %. The composition can be free of or substantially free of polyamic acid precursors of the polyimides. The composition can have a viscosity of 100 to 5000 centipoise, or 150 to 2000 centipoise, or 200 to 1500 centipoise, or 250 to 1000 centipoise, or 300 to 600 centipoise. Also disclosed is a method of coating comprising providing the composition and coating, for example by gravure coating, the composition onto a substrate. The substrate can comprise, comprise as a major component, or consist essentially of a polymer, for example a low cost polymer and/or a low Tg or low Tm polymer where the Tg and/or Tm is less than the cure or dehydration temperature for forming the polyimide from a polyamic acid. Also disclosed herein is an article comprising a film of the polyimide on such a substrate.

### The Polyimide

The polyimide component of the composition can provide excellent electrical insulation properties and/or dielectric strength. The polyimide can have a weight average molecular weight of 80,000 to 250,000, or 100,000 to 200,000, or 110,000 to 160,000 grams/mole as determined by gas permeation chromatography with polystyrene molecular weight calibration.

The polyimide is the reaction product of a reaction mixture including a diphthalic anhydride with a diamine.

The diphthalic anhydride can have the formula I as follows:

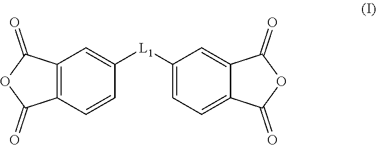

where L₁ is a linking group selected from —O—, —O-Ar-O—, where Ar is a group comprising one or more aromatic ring, and alkylene groups. For example, Ar can be an arylene such as a phenylene. As another example, Ar can comprise more than one aromatic ring. The more than one aromatic rings can be connected by a direct bond or by an alkylene group, for example of 1, 2, 3, 4, or 5 carbon atoms. Where L is an alkylene group, it can comprise, for example, 1, 2, 3, 4, or 5 carbon atoms. The Ar or alkylene groups can be substituted or unsubstituted. For example, the substitution could be fluorine on alkylene linking group or a fluorinated alkyl, e.g., trifluoro methyl, on an aromatic ring, Examples of the dianhydride include

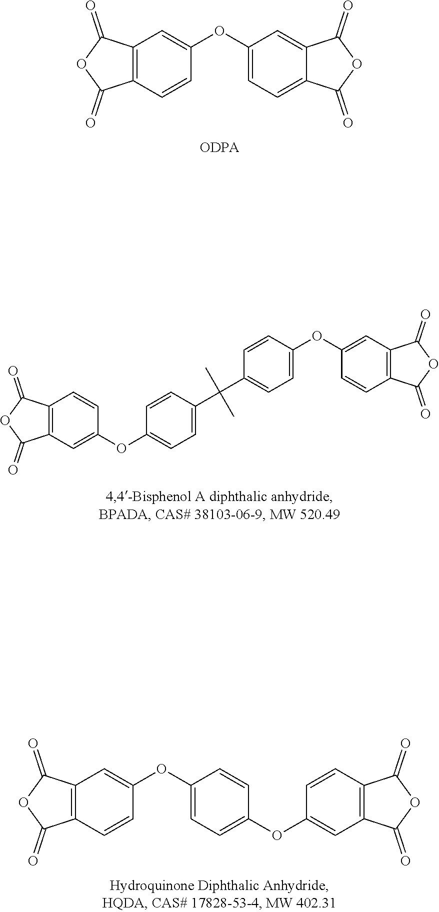 [SMILES: O=C1OC(=O)c2cc(Oc3ccc4c(c3)C(=O)OC4=O)ccc21 ; CC(C)(c1ccc(Oc2ccc3c(c2)C(=O)OC3=O)cc1)c1ccc(Oc2ccc3c(c2)C(=O)OC3=O)cc1 ; O=C1OC(=O)c2cc(Oc3ccc(Oc4ccc5c(c4)C(=O)OC5=O)cc3)ccc21]

A diphthalic anhydride as described above can be a sole diphthalic anhydride in the reaction mixture or more than one of the diphthalic anhydrides described above could be used in combination with each other. The diphthalic anhydride(s) described above could be used in combination of with another dianhydride where the amount of the diphthalic anhydride of formula I (or total of the present species thereof) is at least 85, at least 90, at least 95, at least 98 or at least 99 mole percent based on total amount of the dianhydrides present in the reaction mixture. An example of such other dianhydride is

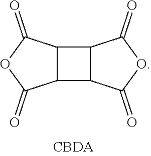 [SMILES: O=C1OC(=O)C2C1C1C(=O)OC(=O)C21]

Without wishing to be bound, it is believed that the linking group can provide flexibility of the structure that can enhance the solubility of the resulting polyimide.

The anhydride is reacted with a diamine to form a polyamic acid. The diamine can have the formula (II)

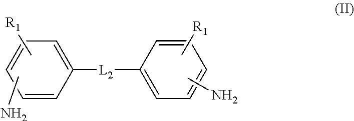

where the amine a groups are at the meta or para positions on the phenyl ring relative to the L₂. R₁ can be H or an alkyl group of 1, 2, 3 or 4 carbon atoms. The alkyl group of R₁ can be substituted, for example with a halogen. For example, R₁ can be trifluoromethyl. R₁ as an alkyl group can be, for example in the ortho position relative to the L₂. L₂ is a direct bond or a linking group selected from —O—, —SO₂—, —OAr₂O—, —R₂Ar₂R₂—, —Ar₂R₂Ar₂—, where R₂ is an alkyl group of 1-4 carbon atoms and Ar₂ is a group comprising one or more aromatic rings. For example, Ar2 can be an arylene such as phenylene.

Examples of diamines include

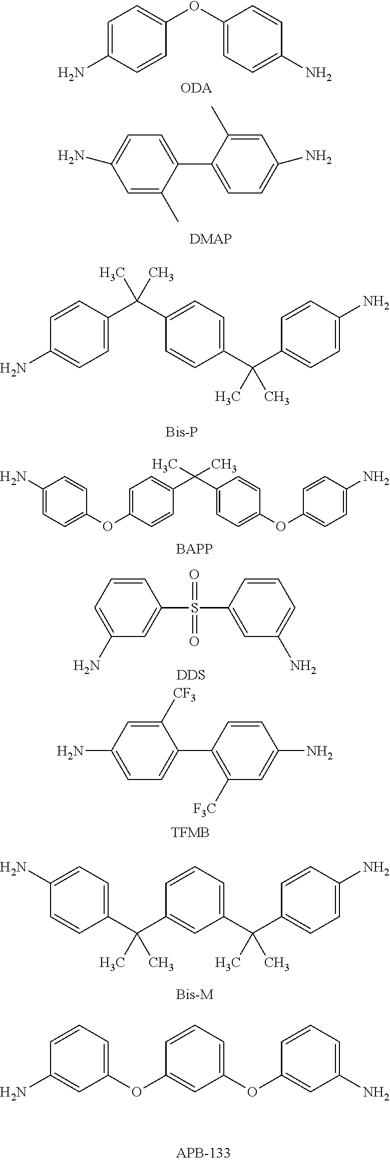

A diamine as described above can be a sole diamine in the reaction mixture (e.g., TFMB can be the sole diamine in the reaction mixture) or more than one of the diamines described above could be used in combination with each other. The diamine(s) described above could be used in combination of with another dianhydride where the amount of the diamine of formula I (e.g., TFMB) (or total of species thereof) is at least 95, at least 98 or at least 99 mole percent based on total amount of the dianhydrides present in the reaction mixture.

The reaction mixture including dianhydride and diamine in a solvent is reacted to form a polyamic acid. The ratio of total moles of dianhydride:total moles of diamine can be about 1:1. The polyamic acid can be terminated for example with: 3Amino Phenol, Trimellitic acid anhydride, phallic anhydride, Aniline, methyl aniline, aliphatic amines (such as butyl amine and dodecyl amine) and maleic anhydride.

The polyamic acid is converted to polyimide by dehydration and/or heating. For example, dehydration can occur by addition of one or more dehydrating agents (e.g., acetic anhydride, propionic anhydride, n-butyric anhydride, benzoic anhydride, acetic benzoic anhydride) and a tertiary amine catalyst such as pyridine, 3-picoline, lutidine, dimethyl aniline, 4-dimethyl aminopyridine, trialkyl amines, triethyl amine, quinoline and N-methyl morpholine, and/or by heating to cure to form the polyimide. For example, Chemical dehydration typically can require minimal heating 80° C. or less for 1-2 hours to ensure complete conversion. Alternatively, the poly(amic acid) may be thermally converted to polyimide solution via azeotropic distillation of water from imidization. In this process, 10-15% azeotropic solvent (such as benzene, toluene or xylenes) is added followed by refluxing from several hours at temperatures in range of 130-180 C.

The polyimide can be precipitated to form a powder which is then redispersed in the desired solvent for coating. Alternatively, it is possible in some instances to form the polyimide in the solvent that is desired for coating in which case the precipitation and redissolution can be avoided. The amount of polyimide based on the total weight of the composition can be from 3 to 30%, 5 to 25%, or 7 to 20% or 10 to 15% by weight.

### Solvent

The solvent can be a solvent having boiling points less than 150° C., or less than 140° C. The solvent can have a boiling point of at least 50° C., or at least 70° C. If the boiling point is too high, solvent removal during coating can take too long or can require heating to a temperature that can damage the polymeric substrate. If the boiling point is too low, rapid evaporation can cause skinning or bubble entrapment. Suitable solvents include, for example, alkyl acetates such as ethyl acetate or butyl acetate; alkoxy alkyl acetates, such as 2-methoxyethyl acetate; carbonate esters, such as dimethyl carbonate (DMC); ketones, such as methyl ethyl ketone (MEK), cyclopentanone; glycol alkyl ethers such as propylene glycol methyl ether; glycol alkyl ether acetates such as propylene glycol methyl ether acetate (PGMEA); alkyl ethers including, cyclic ethers such as tetrahydrofuran (THF), diethers such as dimethoxyethane or triethers. A solvent blend can be used. Such solvent blend can comprise one or more of the exemplary solvents listed above in combination with another such solvent or any other compatible solvent.

The polyimide is dissolved in the solvent. In the compositions disclosed herein the polyimide preferably is soluble in the solvent. The polyimide can be soluble in the solvent when present in amounts of up to 10 or up to 30 weight percent based on total weight of the polyimide and solvent, and preferably in the amount that it is present in the composition. Specifically, solubility can be confirmed if there is no visibly observed turbidity, haze or particulates at room temperature.

### Pigment

The present inventors have discovered that by adding a pigment one can obtain a film with a higher dielectric constant that the polyimide film itself while still maintaining dielectric strength as indicated for example by breakdown voltage along with good mechanical properties. Thus, the composition can include pigment particles (e.g., inorganic pigments or carbon black) in amounts up to 0-15, or 0.05-10, or 0.1 to 5 wt % based on total weight of the composition.

The present inventors have found that using a soluble polyimide enables incorporation of such pigments. In contrast, the polyamic acids can negatively impact the dispersibility of the pigments. Thus, particularly where pigments are included, the composition preferably is free of or substantially free of polyamic acid. By substantially free of is mean less than 5%, or less than 1%, or less than 0.5% or less than 0.1% polyamic acid based on total amount of polyamic acid and polyimide in the composition as determined by Fourier-transform infrared spectroscopy.

Inorganic pigments have been found to be particularly useful for the present invention. Examples of inorganic pigments include opacifying pigments and colorant pigments. Opacifying pigments have high refractive index which leads to increased light scattering in the coating effectively “hiding” the coated substrate. High refractive index pigment are typically inorganics such as Titanium dioxide, Barium Sulfate, Zinc Sulfide, Zinc Oxide, Calcium Carbonates, silicates, sulfates, and oxides. Inorganic colored pigments include iron oxides (yellow, red, browns), Manganese violet, Pigment Blue 27 & 28 (Iron & Cobalt Blue). Carbon black can be used as a pigment.

Organic pigments can be incorporated to adjust color. Some examples of organic pigments with useful coloristic properties: (cyan) Pigment Blue 15:3 and Pigment Blue 15:4; (magenta); Pigment Red 122 and Pigment Red 202; (yellow) Pigment Yellow 14, Pigment Yellow 74, Pigment Yellow 95, Pigment Yellow 110, Pigment Yellow 114, Pigment Yellow 128 and Pigment Yellow 155; (red) Pigment Orange 5, Pigment Orange 34, Pigment Orange 43, Pigment Orange 62, Pigment Red 17, Pigment Red 49:2, Pigment Red 112, Pigment Red 149, Pigment Red 170, Pigment Red 177, Pigment Red 178, Pigment Red 188, Pigment Red 254, Pigment Red 255, and Pigment Red 264; (green) Pigment Green 1, Pigment Green 2, Pigment Green 7 and Pigment Green 36; (blue) Pigment Blue 60, Pigment Violet 3, Pigment Violet 19, Pigment Violet 23, Pigment Violet 32, Pigment, Violet 36 and Pigment Violet 38.

Other pigments also include exfoliated clays and core-shell latex (air filled) pigments have been used as supplemental hiding/opacifying pigment in combination with inorganics such as TiO2.

A pigment described above can be used alone in the composition or in combination with one or more other pigments.

### Coating and Article

The method disclosed herein comprises providing the composition by coating onto a substrate and drying to remove solvent. The coating can occur by gravure coating, spin coating, bar coating, or the like. The drying can be at a temperature of 50 to 170, or 70 to 150, or 80 to 120° C. The drying temperature can be below the Tg or the Tm of the polymeric substrate. Drying can occur over a time of 1 to up to 30 minutes.

The substrate can be a substrate that includes a low cost or a low Tg or low Tm polymer. The substrate can comprise a low cost film. The substrate can comprise a polymeric film having a Tg and/or Tm of less than 200, or less than 180 or less than 160° C. The substrate can comprise for example, an olefinic polymer such as polyethylene, a polypropylene, and copolymers thereof. The substrate can comprise a styrenic polymer such as polystyrene or copolymers of styrene with one or more other monomers. The polymer of the substrate can be a polyester such as polyethylene terephthalate (PET), polybutylene terephthalate (PBT) or polyethylene naphthalate (PEN).

The coating (also referred to herein as the film or layer) on the substrate can have a thickness of 0.5 to 20 microns, 1 to 10 microns or 1 to 5 microns. The coating can have a voltage breakdown of at least 100 or at least 200, or at least 250 volts/micron of thickness. The coating can have a dielectric constant of 3-10, or 4-9. The coating can have a transmission (with no pigment added) of at least 90% at a thickness of 3.5 microns as measured on Eagle glass (TM corning glass). The coating (with no pigment added) can have a transmission of at least 92 or at least 95%. Transmission can be determined by using a spectrophotomer such as a HunterLab UltraScan™.

### EXAMPLES

### Example 1—Polyimide Synthesis

A 500-mL round bottom flask equipped with mechanical stirrer a nitrogen purge was loaded with 30.78 g 2,2′-Bis(trifluoromethyl)benzidine) (“TFMB”) and 171.87 g N-Methyl-2-pyrrolidone (NMP) and mixed for 1 hour. Oxydiphthalic Anhydride (ODPA) in an amount of 29.21 g, was added over 4 hours while rinsing with a total of 168.16 g NMP. After stirring overnight, the reaction mixture had a viscosity of 531.8 centipoise (cP), and 0.299 g ODPA was added to adjust the stoichiometry and increase the viscosity. The viscosity was monitored over a total of 5 days and adjusted with a total of 0.733 g ODPA for a final poly(amic acid) solution viscosity of 3026 cP. The poly(amic acid) was chemically converted to polyimide via the addition of 3-picoline (21.44 g) and acetic anhydride (24.04 g) and mixing overnight. The ODPA/TFMB polyimide was precipitated from NMP. After filtering and drying the fine powder at 80° C. under vacuum, a total of 57.81 g was obtained. As measure by relative GPC, this polyimide powder had a weight average molecular weight Mw of about 260,000 g/mol and a polydispersity of 2.82. The glass transition temperature (Tg) was 294.5° C. based on DSC analysis, and TGA exhibited a 5% weight loss at 540.45° C.

This polyimide powder was found by visible inspection at room temperature to be soluble (at least 10% wt with no haze or turbidity) in several volatile solvents potentially suitable for roll-to-roll gravure or slot-die coating including ethyl acetate, MEK, PGMEA (propylene glycol methyl ether acetate), cyclopentanone, 2-methoxyethyl acetate, and THF.

### Example 2

Polyimide inks were formulated by initially dissolving polyimide dried powder as in Example 1 in cyclopentanone at approximately 12 wt. % solids. A dispersion of TiO₂ (66% solids in PGMEA and butyl acetate) was then added to polyimide solution, and after mixing overnight, the inks were filtered through 5-micron syringe filter. The Table 1 illustrates several examples suitable for spin coating. Alternative coating processes may require additional dilution. For example, for gravure coating a viscosity of 300 to 600 centipoise can be used.

TABLE 1

| | 11.76% PI-1 (above) | Gibraltar 955-39600 | | | Total | |
|---|---|---|---|---|---|---|
| | in cyclopentanone | TiO2 dispersion (66%) | Wt. % | Wt % | Solids, | Viscosity, |
| Ink ID | (parts by weight) | (Parts by weight) | PI | TiO2 | wt % | cP |
| 1A | 76.44 | 3.59 | 11.2 | 3.0 | 14.2 | 2081 |
| 1B | 74.53 | 5.46 | 11.0 | 4.5 | 15.5 | 2124 |
| 1C | 72.43 | 7.59 | 10.6 | 6.3 | 16.9 | 2352 |
| 1D | 70.33 | 9.67 | 10.3 | 8.0 | 18.3 | 2344 |

Films coated from the Inks at about 10 microns were tested for dielectric constant and breakdown voltage using Dielectric Withstand or Hipot (High Potential) Tester according to ASTM D149 IEC60243. Films of 3-5 micron thickness on Eagle glass substrate having a % transmission of 92.01 and L*, a*, b* of 96.833, −0.004, and 0.146, respectively, were tested for color and transmission using Hunter Lab Ultra Scan XE Spectro-Colorimeter. The Table 2 summarizes the data.

TABLE 2

| | | | | Average % | | | |
|---|---|---|---|---|---|---|---|
| | | | | Transmission, | | | |
| | Dielectric | Breakdown | Thickness | 400-750 nm, | | | |
| | Constant, Dk | Voltage, | of film, | 3.5 micron | | | |
| Ink ID | (10 GHz) | V/micron | microns | on Eagle Glass | L* | a* | b* |
| Clear | 3.42 | 253 | 10.8 | 90.01 | 96.06 | −0.016 | 0.5 |
| 1A | 4.30 | 309 | 8.5 | 49.89 | 94.38 | −1.223 | 1.480 |
| 1B | 5.02 | 308 | 9.3 | 46.17 | 94.49 | −1.246 | 1.936 |
| 1C | 5.30 | 253 | 10.0 | 41.20 | 94.82 | −1.170 | 1.733 |
| 1D | 5.80 | 237 | 11.4 | 40.42 | 94.99 | −1.148 | 1.640 |

The data above demonstrates that films with added white pigment (TiO2) have increased dielectric constant for improved electrical performance in capacitance applications while maintaining high breakdown voltage and providing opacity/color for aesthetics.

### Example 3

Polyimides were made according to the procedure as in Example 1. The dianhydride used was either ODPA or 4,4-Bisphenol A diphthalic anhydride (BPADA). The diamine used was either the aromatic diamine, TFMB, or a cycloaliphatic diamine

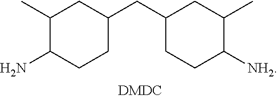 [SMILES: CC1CC(CC2CCC(N)C(C)C2)CCC1N]

The solubility of these polyimides was tested in various solvents as shown in Table 3 at 10 weight percent in the solvent based on total weight of the sample by combining in a vial and vortexing and rolling overnight at room temperature. The results demonstrate that the polyimides made with the aromatic diamine have significantly better solubility in a variety of low temperature solvents. Solubility was evaluated visually at room temperature. A Yes (Y) designation indicates the composition was clear (not cloudy) and had no precipitate. A no (N) designation indicates cloudiness and/or precipitate. An NA designation indicates that combination was not tested.

TABLE 3

| | Solvent | | | | |
|---|---|---|---|---|---|
| | Boiling | Sample ID | | | |
| Solvent | Point (° C.) | BPADA/TFMB | ODPA/TFMB | BPADA/DMDC | ODPA/DMDC |
| PGMEA | 146 | Y | Y | NA | NA |
| (propylene | | | | | |
| glycol methyl | | | | | |
| ether acetate) | | | | | |
| PGME | 120 | Y | N | NA | NA |
| (propylene | | | | | |
| glycol methyl | | | | | |
| ether) | | | | | |
| THF | 66 | Y | Y | Y | Y |
| HBM, hydroxy | 137 | Y | N | N | N |
| isobutyrate | | | | | |
| methyl ester | | | | | |
| methoxyethyl | 145 | Y | Y | N | N |
| acetate | | | | | |
| Dimethyl | 90 | Y | Y | N | N |
| carbonate | | | | | |
| Cyclopentanone | 130 | Y | Y | Y | Y |
| ETHYL | 77 | Y | Y | N | N |
| ACETATE | | | | | |
| MEK | 80 | Y | Y | N | N |

Polyimides of ODPA/TFMB and BPADA/TFMB were also found to be soluble in a solvent blend of PGMEA and butyrol lactone (30/70 weight/weight).

### Example 4

Various polyimides were made as described above with BPADA as the dianhydride in combination with,

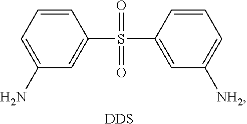 [SMILES: Nc1cccc(S(=O)(=O)c2cccc(N)c2)c1 ; "DDS"]

as shown in Table 4. These were tested as described in Example 3. These polyimides were not soluble in as many solvents as the polyimide from the reaction of BPADA and TFMB, but there were found soluble in certain solvents as shown in Table 4.

TABLE 4

| | Solvent | | | |
|---|---|---|---|---|
| Sample ID | Boiling | | | |
| Solvent | Point (° C.) | BPADA/DDS | BPADA/BAPP | BPADA/BisP |
| tetrahydrofuran | 66 | Y | N | Y |
| (THF) | | | | |
| Dimethyl | 90 | Y | N | N |
| carbonate | | | | |
| Cyclopentanone | 130 | Y | Y | Y |

### Example 5

Polyimide was made as described above with OPDA as the dianhydride in combination with a mixture of BisP and DDS. They were tested for solubility as described in Example 3. While this polyimide was not soluble in as many solvents as the polyimide of ODPA/TFMB, it was found to be soluble in methoxy ethyl acetate, cyclopentanone and a solvent blend of PGMEA and butyrol lactone (30/70).

### Example 6

Comparative compositions were made. The first was a polyimides of

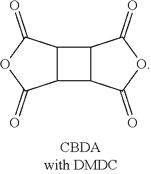 [SMILES: O=C1OC(=O)C2C1C1C(=O)OC(=O)C21]

The second of TAHQ

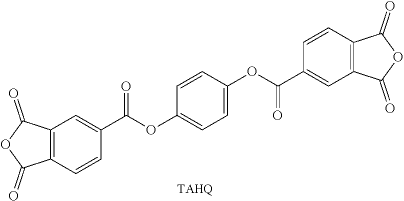

with a mixture of DDS and BisP. These polyimides were tested as described in Example 3. These polyimides were generally found to be insoluble, although the first polyimide was soluble in cyclopentanone and THF.

This disclosure further encompasses the following aspects.

Aspect 1: A composition comprising 3-30, preferably 5 to 30, more preferably 5 to 25, yet more preferably 7 to 20, still more preferably 10-15 weight percent based on total weight of the composition of a polyimide wherein the polyimide is the dehydrated reaction product of a dianhydride component and a diamine component, where the dianhydride component comprises at least 85, preferably at least 90, more preferably at least 95, yet more preferably at least 99, and most preferably 100 mole percent based on total moles of dianhydride component of diphthalic dianhydride having the structure

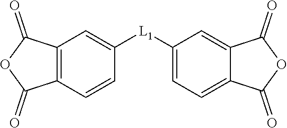

where L₁ is a linking group selected from —O—, —O-Ar1-O—, where Ar1 is a group comprising one or more aromatic ring,
and where the diamine component comprises at least 95, preferably at least 98, and most preferably 100 mole percent based on total moles of diamine component of diamine having the structure

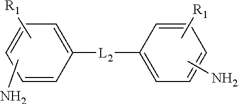

where the amine groups are at the meta or para positions, where the R₁ group is independently in each occurrence H or a substituted alkyl of 1, 2, or 3 carbon atoms, L₂ is a direct bond or a linking group selected from —O—, —SO₂—, —OAr₂O—, —R₂Ar₂R₂— where R₂ is independently in each occurrence an alkyl group of 1, 2, 3, or 4 carbon atoms and Ar₂ is a group comprising one or more aromatic rings; a solvent having a boiling point of less than 150° C., preferably less than 140° C. or preferably 50 to 150° C. and most preferably 70 to 140° C.; and 0-15, preferably 0.05-10, more preferably 0.1 to 5 weight percent based on total weight of the composition of one or more pigments, preferably inorganic pigments.

Aspect 2: The composition of Aspect 1 wherein L1 is —O— or —O-phenyl-C(CH3)2-phenyl-O—.

Aspect 3: The composition of Aspect 1 or 2 wherein the R1 is a halogenated, preferably fluorinated, alkyl.

Aspect 4: The composition of any one of the preceding Aspects wherein L2 is a direct bond.

Aspect 5: The composition of any one of the preceding Aspects wherein the dianhydride is

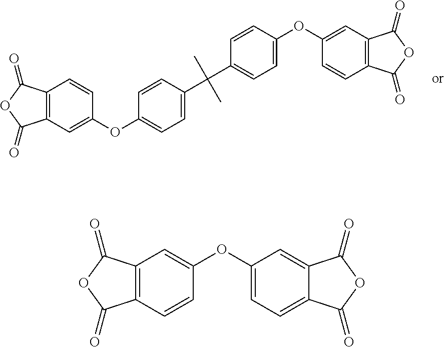 [SMILES: CC(C)(c1ccc(Oc2ccc3c(c2)C(=O)OC3=O)cc1)c1ccc(Oc2ccc3c(c2)C(=O)OC3=O)cc1 ; O=C1OC(=O)c2cc(Oc3ccc4c(c3)C(=O)OC4=O)ccc21]

and the aromatic diamine is bis(trifluoromethyl)benzidine.

Aspect 6. The composition of any one of the preceding Aspects wherein the polyimide is soluble in the solvent at room temperature.

Aspect 7: The composition of any one of the preceding Aspects wherein the polyimide is soluble in the solvent at room temperature at amount of at least 5, preferably at least 10, more preferably at least 20 weight percent.

Aspect 8: The composition of any one of the preceding Aspects wherein the polyimide is soluble in the solvent at room temperature at amount of up to 30 weight percent.

Aspect 9. The composition of any one of the preceding Aspects having a viscosity of 200 to 2000 centipoise, preferably 300 to 600 centipoise.

Aspect 10. The composition of any one of the preceding Aspects wherein the solvent comprises alkyl acetates, preferably ethyl acetate or butyl acetate; alkyoxyalkyl acetates, preferably 2-methoxyethyl acetate; carbonate esters preferably dimethyl carbonate (DMC); ketones, preferably methyl ethyl ketone (MEK) and/or cyclopentanone; glycol alkyl ethers, preferably propylene glycol methyl ether; glycol alkyl ether acetates preferably propylene glycol methyl ether acetate (PGMEA); alicyclic or cyclic alkyl ethers, preferably tetrahydrofuran (THF); diethers, preferably dimethoxymethane; or triethers.

Aspect 11 The composition of any one of the preceding Aspects wherein the pigment comprises from TiO2, a coloring pigment or a combination thereof.

Aspect 12. A method comprising providing the composition of any one of Aspects 1-10 and coating that onto a substrate, drying to form a film on the substrate having a thickness of 1 to 5 micrometers.

Aspect 13. The method of Aspect 12 wherein the coating comprises gravure coating.

Aspect 14. The method of Aspect 12 or 13 where the substrate comprises a flexible polymeric substrate, preferably polyethylene terephthalate or polyethylene naphthalene.

Aspect 15. The method of any one of Aspects 12-14 wherein the substrate comprises a conductive layer.

Aspect 16. The article made by the method of any one of Aspects 12-15.

Aspect 17: The article of aspect 15 characterized by one or more of the following: the film has a dielectric constant of 4-10, the film a percent transmission at 400-750 nm of 1-80%, the film has a breakdown voltage of at least 200 volts/micron.

Aspect 18: An article comprising a substrate comprising a flexible polymer and a conductive layer and having film thereon comprising a polyimide and a pigment where the film is characterized by a dielectric constant of 4-10 and a breakdown voltage of at least 200 volts/micron.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). Moreover, stated upper and lower limits can be combined to form ranges (e.g., “at least 1 or at least 2 weight percent” and “up to 10 or 5 weight percent” can be combined as the ranges “1 to 10 weight percent”, or “1 to 5 weight percent” or “2 to 10 weight percent” or “2 to 5 weight percent”).

The disclosure may alternately comprise, consist of, or consist essentially of, any appropriate components herein disclosed. The disclosure may additionally, or alternatively, be formulated so as to be devoid, or substantially free, of any components, materials, ingredients, adjuvants or species used in the prior art compositions or that are otherwise not necessary to the achievement of the function and/or objectives of the present disclosure.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

Unless specified to the contrary herein, all test standards are the most recent standard in effect as of the filing date of this application, or, if priority is claimed, the filing date of the earliest priority application in which the test standard appears.

1. A composition comprising
a. 5-30 weight percent of a polyimide wherein the polyimide is the dehydrated reaction product of a dianhydride component and a diamine component, where the dianhydride component comprises at least 85 mole percent diphthalic anhydride having the structure 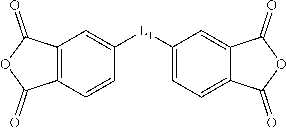
where L₁ is a linking group selected from —O—, —O-Ar1-O—, where Ar1 is a group comprising one or more aromatic ring,
and where the diamine component comprises at least 95 mole percent of diamine having the structure 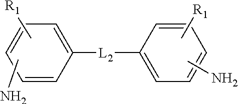
where the amine groups are at the meta or para positions, where the R₁ group is H or a substituted alkyl of 1-3 carbon atoms, L₂ is a direct bond or a linking group selected from —O—, —SO₂—, —OAr₂O—, —R₂Ar₂R₂— where R₂ is an alkyl group of 1-4 carbon atoms and Ar2 is a group comprising one or more aromatic rings; and
b. a solvent having a boiling point of from 70 to less than 150° C., provided that the composition is characterized by one or more of the following:
L1 is —O-Ar1-O—;
the solvent has a boiling point of greater than 80; and
the composition consists essentially of 5 the polyimide and the solvent.

2. The composition of claim 1 wherein L₁ is —O— or —O-phenyl-C(CH₃)₂-phenyl-O—.

3. The composition of claim 1 wherein the R₁ is a halogenated, preferably fluorinated alkyl.

4. The composition of claim 1 wherein L₂ is a direct bond.

5. The composition of claim 1 wherein the dianhydride is 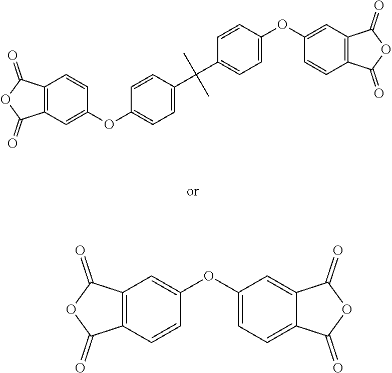 [SMILES: CC(C)(c1ccc(Oc2ccc3c(c2)C(=O)OC3=O)cc1)c1ccc(Oc2ccc3c(c2)C(=O)OC3=O)cc1 ; O=C1OC(=O)c2cc(Oc3ccc4c(c3)C(=O)OC4=O)ccc21]
and the aromatic diamine is bis(trifluoromethyl)benzidine.

6. The composition of claim 1 wherein the polyimide is soluble in the solvent at room temperature.

7. The composition of claim 1 having a viscosity of 200 to 2000 centipoise.

8. The composition of claim 1 wherein the solvent comprises alkyl acetates; alkyloxyalkyl acetates; carbonate esters; ketones; glycol alkyl ethers; glycol alkyl ether acetates; alicyclic or cyclic alkyl ethers, diethers or triethers.

9. The composition of claim 1 wherein the amount of pigment is 0.1 to 5 weight percent.

10. The composition of claim 1 wherein the pigment comprises one or more of Titanium dioxide, Barium Sulfate, Zinc Sulfide, Zinc Oxide, Calcium Carbonates, silicates, sulfates, and oxides. Inorganic colored pigments include iron oxides (yellow, red, browns), Manganese violet, Pigment Blue 27 & 28 (Iron & Cobalt Blue), carbon black.

11. A method comprising providing a composition comprising
a. 5-30 weight percent of a polyimide wherein the polyimide is the dehydrated reaction product of a dianhydride component and a diamine component, where the dianhydride component comprises at least 85 mole percent diphthalic anhydride having the structure 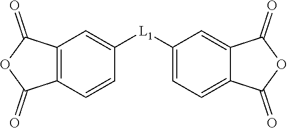
where L₁ is a linking group selected from —O—, —O-Ar1-O—, where Ar1 is a group comprising one or more aromatic ring,
and where the diamine component comprises at least 95 mole percent of diamine having a structure 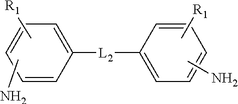
where the amine groups are at the meta or para positions, where the R₁ group is H or a substituted alkyl of 1-3 carbon atoms, L₂ is a direct bond or a linking group selected from —O—, —SO₂—, —OAr₂O—, —R₂Ar₂R₂— where R₂ is an alkyl group of 1-4 carbon atoms and Ar₂ is a group comprising one or more aromatic rings;
b. a solvent having a boiling point of less than 150° C., and
c. 0-15 weight % of one or more pigments, and
gravure coating the composition onto a substrate, drying to form a film on the substrate having a thickness of 1 to 5 micrometers.

12. (canceled)

13. The method of claim 11 where the substrate comprises a flexible polymeric substrate.

14. The method of claim 11 wherein the substrate comprises a conductive layer.

15. An article comprising a polyimide film on a flexible polymeric substrate, wherein the polyimide film comprises polyimide which is the dehydrated reaction product of a dianhydride component and a diamine component, where the dianhydride component comprises at least 85 mole percent diphthalic anhydride having the structure 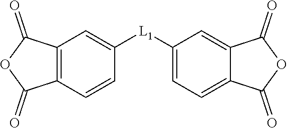
where L₁ is a linking group selected from —O—, —O-Ar1-O—, where Ar1 is a group comprising one or more aromatic ring,
and where the diamine component comprises at least 95 mole percent of diamine having the structure 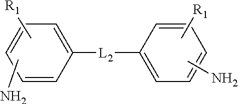
where the amine groups are at the meta or para positions, where the R₁ group is H or a substituted alkyl of 1-3 carbon atoms, L₂ is a direct bond or a linking group selected from —O—, —SO₂—, —O-Ar₂O—, —R₂Ar₂R₂— where R₂ is an alkyl group of 1-4 carbon atoms and Ar₂ is a group comprising one or more aromatic rings; and 0.1-15 weight % of a pigment, said pigment comprising an inorganic pigment or carbon black, wherein the article is a film characterized by
a dielectric constant of 4-10,
a percent transmission at 400-750 nm of 1-80%, and
a breakdown voltage of at least 200 volts/micron.

16. The composition of claim 1 wherein the solvent has a boiling point of 80 to 150° C.

17. The composition of claim 1 wherein the solvent has a boiling point of 90 to 150° C.

18. The composition of claim 1 consisting essentially of the polyimide and the solvent.

19. The composition of claim 1 wherein L1 is —O-Ar1-O—.

20. The composition of claim 1 wherein the dianhydride comprises 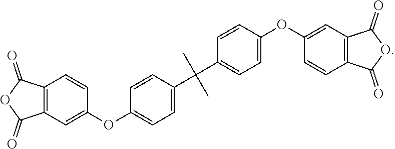 [SMILES: CC(C)(c1ccc(Oc2ccc3c(c2)C(=O)OC3=O)cc1)c1ccc(Oc2ccc3c(c2)C(=O)OC3=O)cc1]
